(19) United States
(12) Patent Application Publication
(10) Pub. No.: US 2017/0082235 A1
(43) Pub. Date: Mar. 23, 2017

(54) WORKING FLUID PIPE FOR TEMPERATURE CONTROL SYSTEM

(71) Applicant: MPI CORPORATION, CHU-PEI CITY (TW)

(72) Inventors: Yueh-Ying LEE, CHU-PEI CITY (TW); Helge Jacob KRYSTAD, CHU-PEI CITY (TW); Ying-Chiao CHANG, CHU-PEI CITY (TW)

(21) Appl. No.: 15/267,726

(22) Filed: Sep. 16, 2016

(30) Foreign Application Priority Data
Sep. 21, 2015 (TW) 104131186

(51) Int. Cl. F16L 59/06; F16L 59/14

(52) U.S. Cl. CPC F16L 59/06; F16L 59/14

(57) ABSTRACT

A working fluid pipe for a temperature control system includes an inner tube unit for a working fluid to flow therethrough, an outer tube unit surrounding the inner tube unit, an air chamber between the inner tube unit and the outer tube unit, and an air inlet and at least one air outlet, which are in communication with the air chamber, for allowing a dry air to enter the air chamber through the air inlet and be vented out of the air chamber from the air outlet. As a result, the working fluid pipe is prevented from frosting and dewing.

### BACKGROUND OF THE INVENTION

1. Field of the Invention

The present invention relates generally to temperature control systems and more particularly, to a pipe for conveying working fluid, which is adapted for being used in a temperature control system.

2. Description of the Related Art

In a task of testing electronic elements or electronic devices composed of electronic elements, such as wafers, integrated circuits, printed circuits, and so on, a tolerance temperature test or a thermal cycle test for a device under test (hereinafter referred to as “DUT”) is one of important tests. This means the DUT has to be tested at various temperatures to learn whether the DUT can be functionally run throughout a specific temperature range. Therefore, a temperature control system is required in the aforesaid testing process to control the ambient temperature of the DUT to a target temperature as accurately as possible. In a conventional temperature control system, a temperature control device capable of adjusting temperature of a working fluid (liquid or gas), such as a refrigeration and air condition device, is used to provide the working fluid at a specific temperature, and a working fluid output device is used to direct the working fluid to the surrounding of a DUT so as to adjust the temperature of the DUT.

Taiwan Patent Publication No. 200936901, corresponding to US Patent Application Publication No. 2009/0100945 A1, discloses a conventional working fluid output device, which includes an output head substantially shaped as an elongated shell, and a protect cover detachably fixed to the bottom of the output head. The working fluid provided by the aforesaid temperature control device is directed into the protect cover that is covered on the DUT through the output head, so that the temperature in the surrounding of the DUT can be quickly changed by the working fluid. The protect cover is provided at the top thereof with an annular groove having a conical surface. The output head is provided at the bottom thereof with a protruded ring, and three bolts penetrating through the protruded ring and abutted against the annular groove, so that the protect cover is fixed to the output head.

In the aforesaid conventional working fluid output device, the protect cover may be replaced by a pipe which is installed at the bottom of the output head for conveying the working fluid to the surrounding of the DUT that is located at a place far away from the output head. The pipe usually includes a flexible tube for the working fluid to flow therethrough, and a thermal insulation surrounding around the flexible tube for preventing the flexible tube from frosting and dewing when the working fluid is conveyed at a very low temperature. To curvedly extend to various locations of the DUT, the flexible tube of the pipe needs to be bendable flexibly and freely. However, in order to achieve thermal insulating effect, the flexible tube has to be thickly wrapped in the thermal insulation, which results in that the pipe is difficult to be bent. In other words, the means for preventing the conventional working fluid pipe from frosting and dewing causes the conventional working fluid pipe disadvantages of a very large external diameter and inconvenience of usage.

### SUMMARY OF THE INVENTION

The present invention has been accomplished in view of the above-noted circumstances. It is an objective of the present invention to provide a working fluid pipe for a temperature control system, which is prevented from frosting and dewing, and has a relatively smaller external diameter, thereby relatively convenient in usage.

To attain the above objective, the present invention provides a working fluid pipe for a temperature control system, which includes an inner tube unit adapted for a working fluid to flow therethrough, an outer tube unit surrounding the inner tube unit, an air chamber between the inner tube unit and the outer tube unit, and an air inlet and at least one air outlet, which are in communication with the air chamber, for allowing a dry air to enter the air chamber through the air inlet and be vented out of the air chamber from the at least one air outlet.

With the above-disclosed technical features, even when the working fluid flowing through the inner tube unit is at a very low temperature, the temperature of the inner tube unit can be raised by supplying the dry air through the air chamber so as to prevent the inner tube unit from frosting and dewing. In this way, the working fluid pipe doesn't need a very thick thermal insulation, but only needs an outer tube unit with a proper thickness to surround the inner tube unit in a way that a small interval is reserved between the inner and outer tube units to form the air chamber. Therefore, compared with the conventional working fluid pipe, the working fluid pipe of the present invention has a relatively smaller external diameter, and is easier to be bent flexibly and convenient in usage.

Preferably, the aforesaid working fluid pipe for the temperature control system has a connection surface adapted for being coupled to an output head that is used for supplying the working fluid, and the connection surface may have at least one air vent communicating with the air chamber. In this way, the dry air in the air chamber can be vented from the air vent to a connection mechanism which connects the working fluid pipe with the output head, so as to prevent the connection mechanism from frosting and dewing.

Preferably, the working fluid pipe is respectively provided at two ends thereof with a connection surface adapted for being coupled to an output head that is used for supplying the working fluid, and a terminal surface where the at least one air outlet may be located. In this way, the dry air and the working fluid both flow through the working fluid pipe from one end to the other end, so each part inside the working fluid pipe can be prevented from frosting and dewing.

Preferably, the working fluid pipe has a connection surface adapted for being coupled an output head that is used for supplying the working fluid, and the air inlet may be located at the connection surface, so that the dry air can be provided to the air inlet from the output head.

In an exemplary embodiment of the present invention, the inner tube unit includes an inner tube, and an inner connector disposed at a top end of the inner tube; the outer tube unit includes an outer tube, and an outer connector disposed at a top end of the outer tube; the inner connector and the outer connector are fixed to each other adapted for being coupled to an output head that is used for supplying the working fluid.

Preferably, the air chamber may include a first annular space located between the inner connector and the outer connector and surrounding the inner connector, and a second annular space located between the inner tube and the outer tube and surrounding the inner tube. In this way, the dry air can be quickly distributed over the surrounding of the inner tube unit, thereby effectively improving the effect of avoiding frost and dew.

Preferably, the working fluid pipe has a connection surface adapted for being coupled to the output head, and the connection surface is composed of a top surface of the inner connector and a top surface of the outer connector and may have at least one air vent communicating with the air chamber so as to prevent a connection mechanism, which connects the working fluid pipe with the output head, from frosting and dewing. More preferably, the connection surface may have a plurality of air vents arranged annularly, thereby effectively improving the effect of preventing the connection mechanism from frosting and dewing.

Preferably, the air inlet may be located at the top surface of the outer connector and the at least one air vent may be located at the top surface of the inner connector. In this way, the dry air can be provided to the air inlet from the output head, and the dry air vented from the air vent located at the inner connector is uneasily dissipated, thereby effectively improving the effect of preventing the connection mechanism from frosting and dewing.

Preferably, the inner tube unit may further include a thermal insulating tube disposed in the inner connector and adapted for accommodating a nozzle of the output head, so that the dry air is prevented from affecting the temperature of the working fluid outputted from the output head.

Preferably, the outer tube unit may further include an upper fixing member disposed at an outside of the outer tube and fixed to the outer connector. Besides, the outer tube unit may further include a lower fixing member disposed at the outside of the outer tube, located at a bottom end of the outer tube, and provided with the air outlet.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is an assembled perspective view of a working fluid pipe for a temperature control system according to a preferred embodiment of the present invention, an output head, and a quick release mechanism;

FIG. 2 is an exploded perspective view of the working fluid pipe for the temperature control system according to the preferred embodiment of the present invention, the output head, and the quick release mechanism;

FIG. 3 is a sectional view taken along the line 3-3 in FIG. 2; and

FIG. 4 is a sectional view taken along the line 4-4 in FIG. 2.

### DETAILED DESCRIPTION OF THE INVENTION

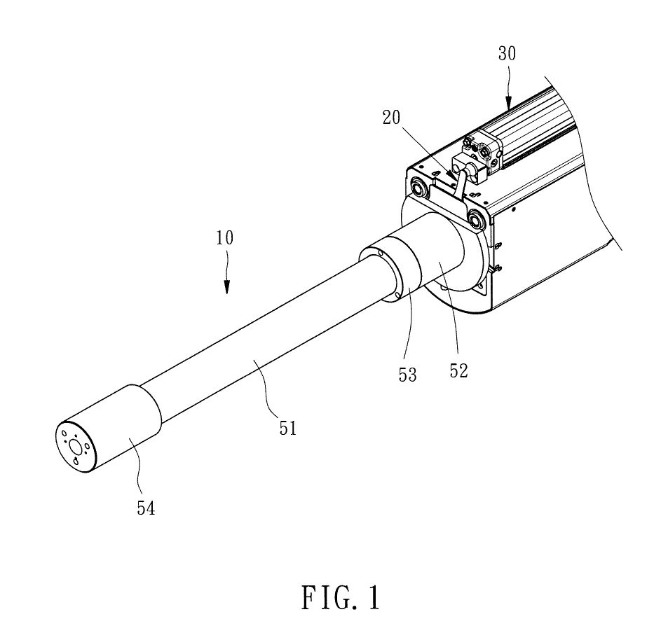

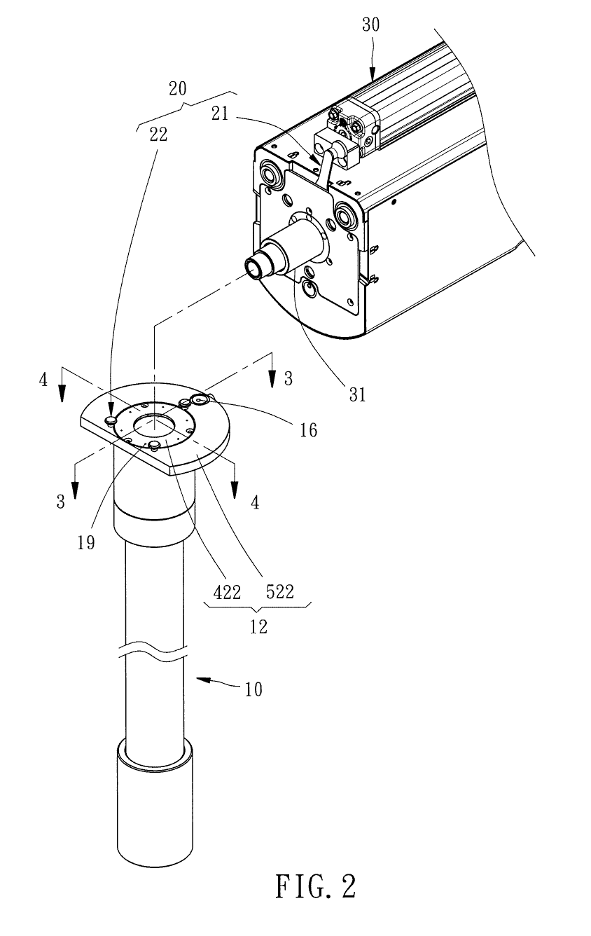

Referring to FIGS. 1-2, a working fluid pipe 10 for a temperature control system according to a preferred embodiment of the present invention is adapted for being detachably mounted to the bottom of an output head 30 by means of a quick release mechanism 20. The output head 30 receives a working fluid (liquid or gas) with a predetermined temperature provided by a temperature control device (not shown) such as a refrigeration device. The working fluid in the output head 30 is outputted to the working fluid pipe 10 from a nozzle 31, and conveyed to the surrounding of a DUT (not shown) through the working fluid pipe 10.

The quick release mechanism 20 includes a first unit 21 disposed at the bottom of the output head 30, and a second unit 22 disposed at the top of the working fluid pipe 10. The quick release mechanism 20 is detailedly described in another patent application (US 2016/0169429 A1) of the applicant of the present invention. The quick release mechanism 20 and the output head 30 are less related to the technical features of the present invention, thereby not being specifically and repeatedly described hereinafter.

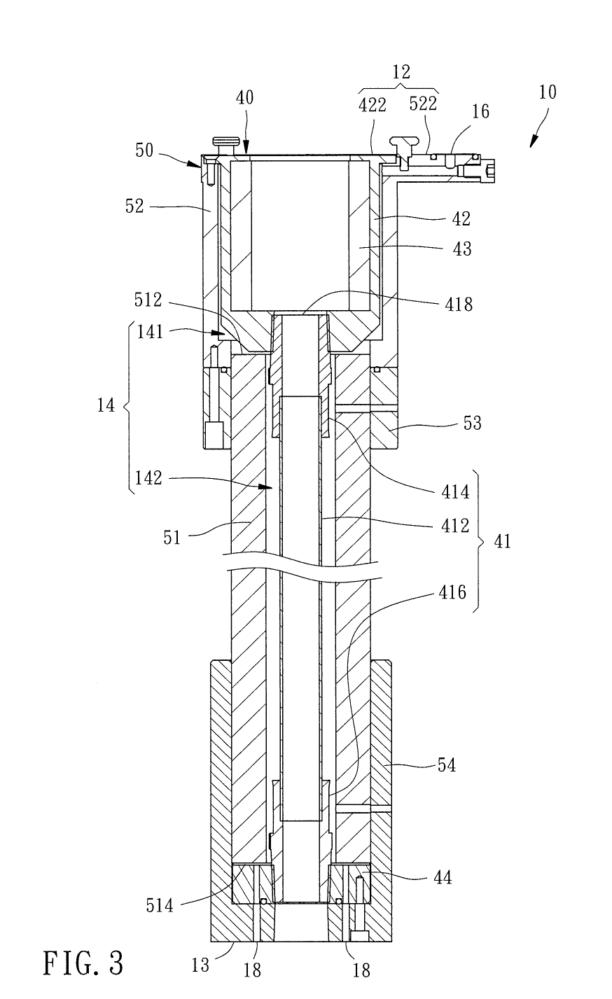

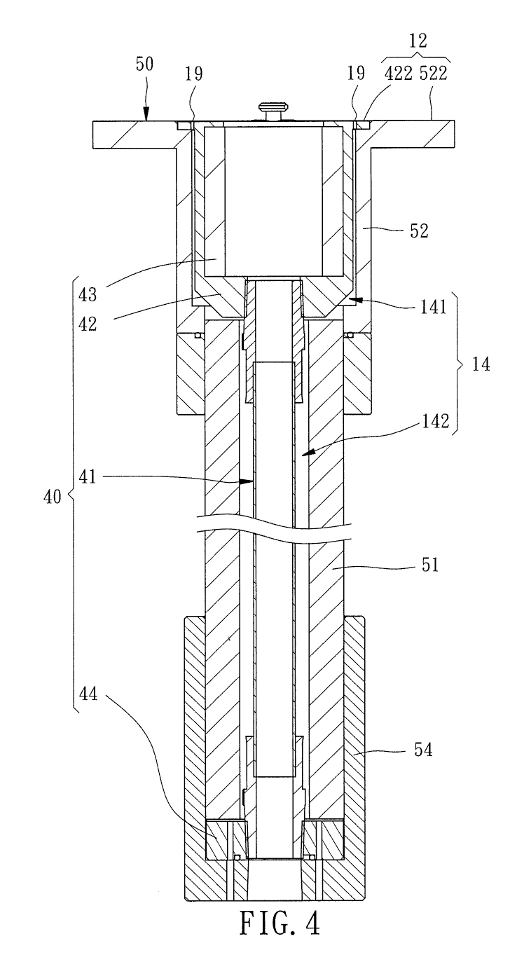

Referring to FIGS. 3-4, the working fluid pipe 10 includes an inner tube unit 40, and an outer tube unit 50 surrounding around the inner tube unit 40.

The inner tube unit 40 includes an inner tube 41, an inner connector 42, a thermal insulating tube 43, and a downside inner connector 44. The inner tube 41 includes a flexible tube 412, which may, but not limited to, be a Teflon tube wrapped in a knitted mesh made of stainless steel, and two threaded fasteners 414, 416 fixed at two ends of the flexible tube 412 respectively and having external threads. The inner connector 42 is screwingly sleeved onto the threaded fastener 414 and located at a top end 418 of the inner tube 41. The thermal insulating tube 43 is made of a thermal insulating material such as silicone rubber, and disposed in the inner connector 42. The downside inner connector 44 is screwingly sleeved onto the threaded fastener 416.

The outer tube unit 50 includes an outer tube 51, an outer connector 52, an upper fixing member 53, and a lower fixing member 54. The outer tube 51 is made of a thermal insulating material such as silicone rubber and spacedly surrounds the inner tube 41. The upper fixing member 53 is fixed at the outside of the outer tube 51. The outer connector 52 is fixed to the upper fixing member 53, and located at a top end 512 of the outer tube 51. The inner connector 42 and the outer connector 52 are fixed to each other. The lower fixing member 54 is fixed at the outside of the outer tube 51, located at a bottom end 514 of the outer tube 51, and fixed to the downside inner connector 44 of the inner tube unit 40.

The inner connector 42 and the outer connector 52 are combinedly adapted for being coupled with the output head 30. Specifically speaking, a top surface 422 of the inner connector 42 and a top surface 522 of the outer connector 52 combinedly form a connection surface 12 which is coupled to a bottom surface of the output head 30 when the working fluid pipe 10 is mounted to the bottom of the output head 30. This means the connection surface 12 is connected with the bottom surface of the output head 30 by the quick release mechanism 20, and the nozzle 31 of the output head 30 is inserted into the thermal insulating tube 43 of the inner tube unit 40.

With the above-disclosed design of the working fluid pipe 10, the working fluid can flow through the inner tube unit 40, and an air chamber 14 is formed in the interval between the inner tube unit 40 and the outer tube unit 50. In this embodiment, the air chamber 14 includes a first annular space 141 located between the inner connector 42 and the outer connector 52 and annularly surrounding the inner connector 42, and a second annular space 142 located between the inner tube 41 and the outer tube 51 and annularly surrounding the inner tube 41, as shown in FIG. 4. However, the air chamber 14 is not limited to be configured as being annularly shaped.

Besides, as shown in FIG. 3, the working fluid pipe 10 is provided at two ends thereof with the aforesaid connection surface 12 and a terminal surface 13, respectively. The connection surface 12 has an air inlet 16, and the terminal surface 13 has a plurality of air outlets 18. Specifically speaking, the air inlet 16 is located at the top surface 522 of the outer connector 52, and the air outlets 18 penetrate through the downside inner connector 44 and the lower fixing member 54. The air inlet 16 and the air outlets 18 communicate with the air chamber 14 for allowing the dry air, which may be heated beforehand, to enter the air chamber 14 through the air inlet 16 and be vented out of the air chamber 14 from the air outlets 18. As a result, even when the working fluid flowing through the inner tube is at a very low temperature, the temperature of the inner tube unit 40 can be raised by circulating the dry air through the air chamber 14 so as to prevent the inner tube unit 40 from frosting and dewing. For the dry air, air having the dew point below 0° C. may preferably, but not limited to, be used, and more preferably, air having the dew point below −30° C. may be used; for example, the air having the dew point of −60° C. can serve as the dry air to achieve great effect. In this way, the working fluid pipe 10 doesn't need a very thick thermal insulation, but only needs the outer tube unit 50 with a thin thickness to surround around the inner tube unit 40 in a way that a small interval is reserved between the inner and outer tube units to form the air chamber 14. Therefore, compared with the conventional working fluid pipe, the working fluid pipe 10 of the present invention has a relatively smaller external diameter, and is easier to be bent flexibly and convenient in usage.

In this embodiment, the air inlet 16 is located at the top surface 522 of the outer connector 52, i.e. located at the connection surface 12 for being coupled to the output head 30. Therefore, the dry air can be provided to the air inlet 16 from the output head 30. However, the air inlet 16 can be provided at other positions, and the dry air can be provided to the air inlet 16 from another device rather than the output head 30. Besides, the inner tube unit 40 may be configured without such thermal insulating tube 43; however, with the thermal insulating tube 43, the thermal insulating tube 43 can accommodate the nozzle 31 of the output head 30 and prevent the dry air from affecting the temperature of the working fluid outputted from the output head 30.

The connection surface 12 of the working fluid pipe 10 may, but not limited to, have at least one air vent 19 communicating with the air chamber 14 and having a diameter smaller than the diameter of the air inlet 16. In this embodiment, the connection surface 12 has a plurality of air vents 19 annularly arranged around a center thereof, as shown in FIGS. 2 and 4. In this way, the dry air circulating in the air chamber 14 can be vented to the quick release mechanism 20 from the air vents 19, so as to prevent the quick release mechanism 20 from frosting and dewing.

It will be appreciated that the amount, arrangement and position of the air vent 19 are not limited to that illustrated in this embodiment; the amount and arrangement of the air outlet 18 are also not limited to that illustrated in this embodiment. Besides, the air chamber 14 is not limited to be shaped annularly; however, the air chamber 14 with such annular design as illustrated in this embodiment can effectively improve the effect of avoiding frost and dew. Further, under the condition that the temperature of the dry air circulating through the air chamber 14 is higher than the temperature of the working fluid conveyed through the inner tube unit 40 and/or the dry air circulating through the air chamber 14 has a humidity lower than a humidity of the working fluid conveyed through the inner tube unit 40, a humidity of ambient air around the working fluid pipe 10 or a standard ambient humidity of atmosphere, a certain good effect of avoiding frost and dew can be achieved. Furthermore, the aforesaid effect will be further enhanced if the air chamber 14 is configured surrounding around the inner tube unit 40.

It is to be mentioned that the working fluid pipe 10 of the present invention is not limited to be applied in such working fluid output device with the quick release mechanism 20 as illustrated in this embodiment. This means the working fluid pipe 10 is not limited to be mounted to the bottom of the output head 30 by means of such quick release mechanism 20 as illustrated in this embodiment and the aforesaid US 2016/0169429 A1. For example, the working fluid pipe 10 and the output head 30 can be connected by a bolt-type mechanism, such as the one provided in Taiwan Patent Publication No. 200936901 mentioned in the above description of the related art.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A working fluid pipe for a temperature control system, the working fluid pipe comprising an inner tube unit for a working fluid to flow therethrough, an outer tube unit surrounding the inner tube unit, an air chamber between the inner tube unit and the outer tube unit, and an air inlet and at least one air outlet, which are in communication with the air chamber, for allowing a dry air to enter the air chamber through the air inlet and be vented out of the air chamber from the at least one air outlet.

2. The working fluid pipe as claimed in claim 1, comprising a connection surface for being coupled to an output head that is used for supplying the working fluid;
wherein the connection surface has at least one air vent communicating with the air chamber.

3. The working fluid pipe as claimed in claim 2, wherein the connection surface has a plurality of said air vents arranged annularly.

4. The working fluid pipe as claimed in claim 1, comprising two ends provided with a connection surface for being coupled to an output head that is used for supplying the working fluid, and a terminal surface, respectively; wherein said at least one air outlet is located at the terminal surface.

5. The working fluid pipe as claimed in claim 1, comprising a connection surface for being coupled to an output head that is used for supplying the working fluid; wherein the air inlet is located at the connection surface.

6. The working fluid pipe as claimed in claim 1, wherein the inner tube unit comprises an inner tube, and an inner connector disposed at a top end of the inner tube; the outer tube unit comprises an outer tube, and an outer connector disposed at a top end of the outer tube; the inner connector and the outer connector are fixed to each other for being coupled to an output head that is used for supplying the working fluid.

7. The working fluid pipe as claimed in claim 6, wherein the air chamber comprises a first annular space located between the inner connector and the outer connector and surrounding the inner connector, and a second annular space located between the inner tube and the outer tube and surrounding the inner tube.

8. The working fluid pipe as claimed in claim 6, comprising a connection surface for being coupled to the output head; wherein the connection surface is composed of a top surface of the inner connector and a top surface of the outer connector and has at least one air vent communicating with the air chamber.

9. The working fluid pipe as claimed in claim 8, wherein the connection surface has a plurality of said air vents arranged annularly.

10. The working fluid pipe as claimed in claim 8, wherein the air inlet is located at the top surface of the outer connector; the at least one air vent is located at the top surface of the inner connector.

11. The working fluid pipe as claimed in claim 6, wherein the inner tube unit further comprises a thermal insulating tube disposed in the inner connector.

12. The working fluid pipe as claimed in claim 1, wherein the air chamber surrounds around the inner tube unit; the dry air for circulating through the air chamber has a temperature higher than a temperature of the working fluid for flowing through the inner tube unit, and the dry air has a humidity lower than a standard ambient humidity of atmosphere.

13. The working fluid pipe as claimed in claim 1, wherein the air chamber surrounds around the inner tube unit; the dry air for circulating through the air chamber has a temperature higher than a temperature of the working fluid for flowing through the inner tube unit, and the dry air has a dew point below −30° C.
